(19) United States
(12) Patent Application Publication
(10) Pub. No.: US 2014/0008405 A1
(43) Pub. Date: Jan. 9, 2014

(54) Wheel A Phone

(71) Applicant: Pamela L. Beaver, Los Angeles, CA (US)

(72) Inventor: Pamela L. Beaver, Los Angeles, CA (US)

(21) Appl. No.: 13/914,560

(22) Filed: Jun. 10, 2013

Related U.S. Application Data
(60) Provisional application No. 61/689,597, filed on Jun. 8, 2012.

(51) Int. Cl. B60R 11/02

(52) U.S. Cl. CPC B60R 11/0241
USPC 224/276

(57) ABSTRACT

The invention provides a specially designed holder for cellular telephones, designed expressly to be attachably mounted to a vehicle steering wheel. The Wheel A Phone provides motorists with a hands free means of utilizing their cellular telephone while on the road, thus enabling them to focus their attention on operating their vehicle.

### CLAIM OF PRIORITY

This patent application claims priority under 35 USC 119 (e) (1) from U.S. Provisional Patent Application Ser. No. 61/689,597 filed Jun. 8, 2012, of common inventorship herewith entitled, “Wheel A Phone.”

### FIELD OF THE INVENTION

The present invention pertains to the field of cellular phones, and more specifically to the field of cellular phone holders.

### BACKGROUND OF THE INVENTION

The prior art has put forth several designs for cellular phone holders. Among these are:

US Patent 2007/0029359 to Jon C. Smith describes a device for supporting objects on a steering wheel, in particular a device for supporting a cell phone on a steering wheel. The device has at least one central member, at least one gripping means, and at least one attachment area capable of supporting the object. The device may include adjustment means capable of varying the length of the central member and the pressure exerted by the gripping means inward on the steering wheel. The device may include at least one support arm and be located outward of the steering wheel's inner hub when secured to the steering wheel.

U.S. Pat. No. 6,983,170 to Jerry Stulberger describes a cellular telephone releasably attached to an airbag cover of a vehicular steering wheel. The present invention is attached by hook and loop material or by a strap means. Power to the telephone is supplied by a cord receiving power from a twelve volt cigarette lighter outlet. Positioned between the cellular telephone and the cigarette lighter is a spring loaded retractor means which stores and releases cord as the steering wheel is turned. The present invention also comprises an awaken mode which activates a preprogrammed telephone call for lethargic users.

U.S. Pat. No. Design 7,370,781 to Gwendolyn Gambrill describes a versatile holder or holster for portable telephones and other personal items, wherein the holder is secured to either side of the body of the user in any physical orientation either horizontal or vertical. The versatile portable telephone holder or holster of the present invention securely retains the portable telephones telephone or other personal items, regardless of the physical orientation of the holder.

None of these prior art references describe the present invention.

### SUMMARY OF THE INVENTION

It is an object of the present invention to provide a functional cellular phone holder that attaches to a steering wheel inside a vehicle.

### BRIEF DESCRIPTION OF THE DRAWINGS

FIG. 1 contains two prototypical front views showing phone cases and functionality of magnetized flaps which secure inserted phones in place.

FIG. 2 is a functional side view showing a rubber grip with an adjustable hook that grips on to a steering wheel.

FIG. 3 is an illustrative front view showing the present invention attached to a steering wheel inside a beta vehicle.

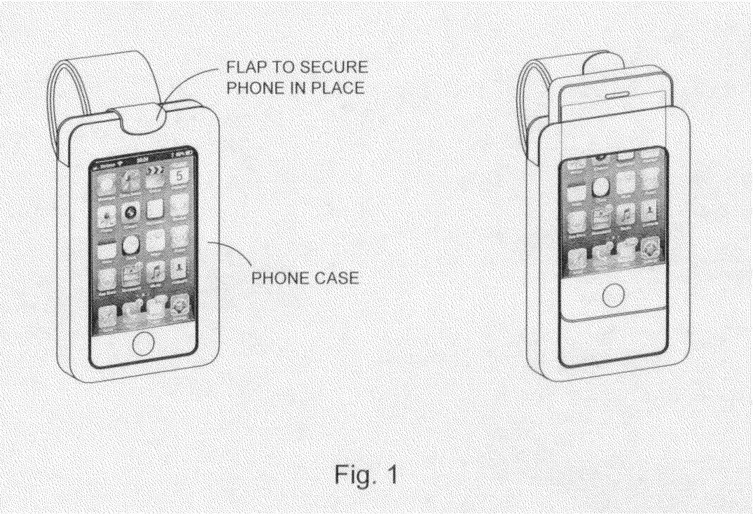

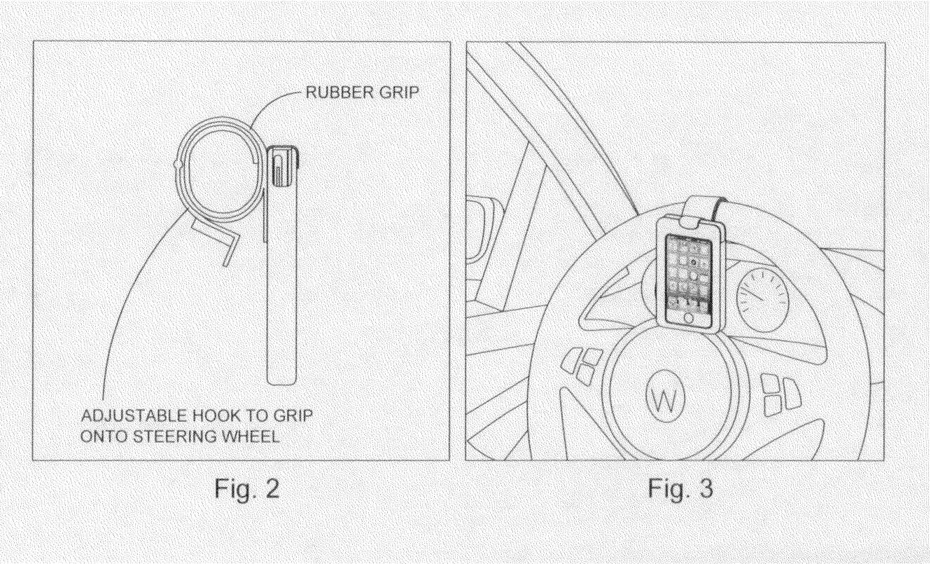

### DETAILED DESCRIPTION OF THE INVENTION

Cellular telephones are a primary source of communication for millions of consumers. Today's widespread use of these revolutionary devices is unsurprising, since cellular telephones now offer a virtually endless variety of benefits. In addition to serving as a practical means of mobile communication, technological advances have evolved cell phones into mini computers. Capable of keeping consumers abreast of the latest stock quotes, providing wireless Internet access and delivering local weather updates, cellular and digital telephones have become practically indispensable to consumers all over the world. With an increased dependence on cellular telephone technology, consumers look for more practical and convenient ways to use these necessary devices. Many consumers find it convenient to use their cellular telephone while driving. Whether scheduling an important meeting, discussing business over the phone or arranging for a play date for one's child, talking on the phone during travel provides consumers a simple means of multitasking and making the most of time spent behind the wheel. Unfortunately, holding onto a cell phone and engaging in conversation when driving is dangerous. Many states and local government agencies have mandatory laws that prohibit use of a cellular phone when operating a vehicle, unless one is using a telephone headset or a Bluetooth earpiece. Many consumers dislike wearing these devices as they cause discomfort and irritation to the delicate ear tissue, especially if one is using the phone for extended periods. With the sound of the user's voice blasted directly into the ear, these devices are painful especially if talking with a person who has a loud voice or has their microphone setting on high. Bluetooth devices and comparable headsets are expensive and easily misplaced, so consumers are resistant to splurge on these devices. While today's cellular telephones contain speaker setting to provide hands free communication, the speaker and microphone work at a short range and to maximize reception, a user usually holds their phone in hand when using the speaker function.

The present invention, hereinafter referred to as Wheel A Phone, is a specially designed holder for cellular telephones, designed expressly to be attachably mounted to a vehicle steering wheel. The Wheel A Phone provides motorists with a hands free means of utilizing their cellular telephone while on the road, thus enabling them to focus their attention on operating their vehicle. The Wheel A Phone allows positioning a phone's speaker and microphone within close range of a user. The Wheel A Phone is comprised of an actual cellular phone holder with a secure brace in which the phone is safely inserted. A hanging hook integrally attached to the holder's underside is designed to firmly grip or crimp on to the vehicle's steering wheel. The Wheel A Phone is fabricated of sleek leather, rubber, silicone or shatterproof plastic. Rectangular in shape, the actual cellular phone holder is manufactured in a variety of sizes and shapes to accommodate various cellular telephones available on the market. The holder's backside is solid with a retaining wall configured to border the perimeter of the phone itself, providing a secure grip on the phone without obstructing the phone's keypad; microphone or speakers. The actual hanging hook is integrally attached to the back of the holder and is easily secured over the vehicle steering wheel. A pliable metal or comparable clamp fastener allows the hanging hook to crimp over the wheel's hand grip.

Use of the Wheel A Phone is very simple and straight forward. The user purchases a size to accommodate their cellular phone, selecting style and material that appeals to them. A business professional selects a stylish leather Wheel A Phone for use with a Blackberry phone, while a college student selects a simple rubber holder for use with a Nokia phone. Once purchased, a user installs the Wheel A Phone over their vehicle steering wheel according to easily followed packaging instructions. After placing the hook fastener over the top of a steering wheel's hand grip, a user makes necessary adjustments to crimp and securely fasten the hook in place. The user then simply inserts their cellular telephone within the Wheel A Phone so the phone is upright and faces forward. When the user makes a call, they activate the phone's speaker function and have a conversation with a colleague or friend while safely operating their vehicle. Upon arriving at their destination, the user removes their phone from the Wheel A Phone holder while leaving the present invention in place on the steering wheel for easy access when again needed. Durably constructed, the Wheel A Phone will withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A functional cellular phone holder device attachably mounted to a steering wheel inside a vehicle, comprising: a secure brace in which the phone is safely inserted, a hanging hook integrally attached to the holder's underside designed to firmly grip or crimp on to the vehicle's steering wheel.

2. The cellular phone holder device of claim 1 fabricated of sleek leather, rubber, silicone or shatterproof plastic.

3. The cellular phone holder device of claim 1 wherein the holder is essentially rectangular in shape, manufactured in a variety of sizes and shapes to accommodate various cellular telephones available on the market.

4. The cellular phone holder device of claim 1 wherein the holder's backside is solid with a retaining wall configured to border the perimeter of the phone itself, providing a secure grip on the phone without obstructing the phone's keypad, microphone or speakers.

5. The cellular phone holder device of claim 1 wherein the hanging hook is integrally attached to the back of the holder and is easily secured over the vehicle steering wheel.

6. The cellular phone holder device of claim 5 Wherein a pliable metal or comparable clamp fastener allows the hanging hook to crimp over the wheel's hand grip.
